(19) United States
(12) Patent Application Publication
(10) Pub. No.: US 2008/0294521 A1
(43) Pub. Date: Nov. 27, 2008

(54) Multilanguage Self-Contained Unmanaged Database-Driven Real Time Digital Advertising Display System

(76) Inventor: Anatoliy Rozman, Cranston, RI (US)

Correspondence Address: Anatoliy Rozman, 121 Castleton Drive, Cranston, RI, 02921, US

(21) Appl. No.: 11/872,011

(22) Filed: Oct. 13, 2007

Related U.S. Application Data
(60) Provisional application No. 60/939,109, filed on May 21, 2007.

(51) Int. Cl. G06Q 30/00

(52) U.S. Cl. 705/14

(57) ABSTRACT

The present invention relates generally to an electronic display system and more particularly, to a database-driven electronic display system.

The revolutionary invention of Multilanguage Self-Contained Unmanaged Database-Driven Real Time Digital Advertising Display System provides a fast and efficient way to advertise and promote products and services in any language for all kinds of retail companies by reaching out and targeting audience via display and, most importantly, dramatically saves time and money for any company around the world.

Retail Companies could utilize existing seasonal and weekly merchandise related promotional information from corporate databases like Oracle, Microsoft SQL or MySQL by displaying inside the stores or outside—as billboards.

Multilanguage Self-Contained Unmanaged Database-Driven Real Time Digital Advertising Display System communicates via High Speed Internet Connection thus all updated information will be delivered in real time. Multilanguage Self-Contained Unmanaged Database-Driven Real Time Digital Advertising Display System communicates via Internet with DSL, T1/T3 Line, High Speed Internet Cable Modem, Wireless Broadband Network, Dial-up connection utilizing VPN (Virtual Private Network), SSH, SSL2/3 secure technology or can utilize forms of CD, DVD, Flash Memory, and Smart Card.

### CROSS-REFFERENCE TO RELATED APPLICATIONS

This application claims the benefit of provisional patent application application Ser. No. 60939109, Confirmation No. 1332, Receipt Date 2007 May 21, Filed 2007 May 21 by the attorney Joshua Adam Stockwell (Attorney Docket Number R045 P01513-US)

### FEDERALLY SPONSORED RESEARCH

Not Applicable

### SEQUENCE LISTING OR PROGRAM

Not Applicable

### BACKGROUND

1. Field of the Invention

The present invention relates generally to electronic display systems and more particularly to a database-driven electronic display system. 2. Background of the Related Art

Retail stores of all kinds use many printed signs and banners to advertise products for sale in their stores. These signs are often changed frequently due to a number of factors, such as price fluctuations, periodic sales, and general rotation to keep them fresh to the customer, among others. As a consequence, retailers continually have to update and hang new signs and banners often times weekly and even daily to keep up with the fast paced retail market. Besides the monetary cost of procuring new signs and banners, retailers must also devote manpower to hanging the new signs and banners and the cost of disposing of the paper signs and banner. Also, paper signs and banners, if misprinted, cannot be easily corrected and must be reordered.

Accordingly, there is a perceived need for a system to replace paper signs and banners that is easily updated and does not require employees to be assigned to updating the retail location's signage.

The costs of paper signs and banners are further exacerbated when the retailer has multiple retail locations. Furthermore, if the retailer operates retail locations that are in another country or cater to customers communicating in different languages, the paper signs and banners must be ordered for different currencies and/or translated into other languages.

Accordingly, there is a perceived need for a system that replaces paper signs and banners that overcomes the disadvantages of having to account for multiple retail locations. Furthermore, there is a perceived need for a system that can handle multiple languages and currencies.

The objects and advantages of the present invention are to provide systems, products and methods that are useful in optimizing a retail product for better selling varieties and for promoting public services. This means determining which categories of products should be expanded and which should be reduced or removed. This optimization can be done to bring the maximum benefit from a fixed number of products or to a limited retail space.

Multilanguage Self-Contained Unmanaged Database-Driven Real Time Digital Advertising Display System works with conjunctions weekly and seasonal promotion programs design the same across all media—newspaper, flyers, signs in the stores.

Additional benefits include, completely eliminating mistakes with pricing information, during printing process. Once description of the product was proofed on database, it stays the same all the time.

### SUMMARY OF THE INVENTION

The present invention solves the problems of the prior art by providing a database driven electronic display system, as shown and described in the attached inventor disclosure. The attached inventor disclosure is incorporated herein by reference. The display system multiple electronic display signs that are capable of being updated remotely through wired and/or wireless transmission means. The core of the system includes a central database that maintains advertising information including details such as product names, product pictures and pricing information among other information. The central database provides this display information to the multiple electronic display signs and operates in real-time. Accordingly, any single display may be updated nearly instantaneously with accurate product information contained in the central database. Each electronic display can be controlled individually and have different product information displayed at any time.

Multiple electronic displays are positioned within one or more retail locations. Each display may be located at various locations that paper signs and banners are often placed. For instance, the electronic displays may be suspended from the ceiling or walls, or affixed directly to shelving units. Optionally, the electronic displays may also be positioned on free-standing floor stands that may be repositioned within the retail location as desired.

The electronic displays can be of any size, from small screens of three or four inches, useful for displaying product pricing information, up to and exceeding billboard size monitors greater than fifty feet, useful for attracting customers traveling on the highway.

Any modification to the product information store in the central database causes the central database to automatically propagate the changes to the multiple electronic displays.

The product information that is sent to each electronic display can be set to change periodically according to a user set parameter. This parameter can be set to as little as a few seconds to as great as a few weeks or indefinitely if desired. This feature permits product information to be rotated through the display keeping it fresh and interesting to consumers. Although static product information can be shown on the electronic displays, such as text and pictures, animated product information can also be shown too. This animated product information can include rotating three-dimensional representations of products in addition to commercial advertisements stored as short movie files. Short movie files can be set to repeat play in a loop.

Furthermore, the central database contains functions to automatically translate the product information into local languages and the product price into local currency units. In lieu of translation, product information may also be stored in multiple languages as well to facilitate the situation where literal translations are awkward or misleading.

The central database also includes functions to set different prices for a product depending upon a number of factors, such as, but not limited to, geographic location and date and time for instance. Moreover, each price for a retail location maybe adjusted to reflect a discreet sale price offered at that particular retail location or to account for surcharges and taxes and/or other levies and costs unique to a particular location.

The system can also be integrated with customer data to produce direct marketing materials. For instance, the system can send product information to cellular phones of current customers. Furthermore, the electronic displays may be located in places other than retail locations. For instance, smaller displays can be mounted in public transportation systems, such as taxis, busses and passenger rail, subway and trolley systems.

The central database is managed and maintained at a single location, thus permitting management complete control over the product information displayed throughout the system. This provides the advantages of providing uniform and accurate product information throughout all of the retail locations, thus minimizing errors. Moreover, the timeliness of the product information is always as current as the information stored in the central database.

Because the multiple displays can be controlled through a variety of transmission means, the internet provides a mode to enable the system to be deployed almost anywhere in the world. With the inclusion of cellular, satellite and other radio transmission means, the system can be extended virtually anywhere in the world. Furthermore, the central database can be managed and controlled from virtually anywhere in the world and need not be located at any of the respective retail locations. Further details may be found in the attached inventor disclosure.

Therefore, it can be seen that the present invention provides a unique solution to the problem of providing a system to replace paper signs and banners in multiple retail locations. The system described herein allows for uniform and nearly instantaneous updates of all signs in multiple retail locations, including those located in other countries. Moreover, the system can be managed at a central location.

It would be appreciated by those skilled in the art that various changes and modifications can be made to the illustrated embodiments without departing from the spirit of the present invention. All such modifications and changes are intended to be within the scope of the present invention.

AD Software Engine module for Multilanguage Self-Contained Unmanaged Database-Driven Real Time Digital Advertising Display System is preferably adapted to display data having any one of a number of different formats, such as:

a) Video;

b) Audio;

c) Graphics;

d) Multimedia;

e) Text.

The multimedia files may include any one of a number of different types of data such as flash, avi, mov, mpegs.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 shows an example of how the Multilanguage Self-Contained Unmanaged Database-Driven Real Time Digital Advertising Display System is securely connected to the internet to advertise product (services) in different countries, cities, stores in different languages, and different currencies according to the teachings of the present invention.

FIG. 2 shows a rear view of diagram connection of Multilanguage Self-Contained Unmanaged Database-Driven Real Time Digital Advertising Display System to a commercially available or custom made build-in computer system.

FIG. 3 shows an enlarged view of AD Software Engine module layout that illustrates kiosk mode of operation of advertising display device shown in FIG. 1 according to the present invention.

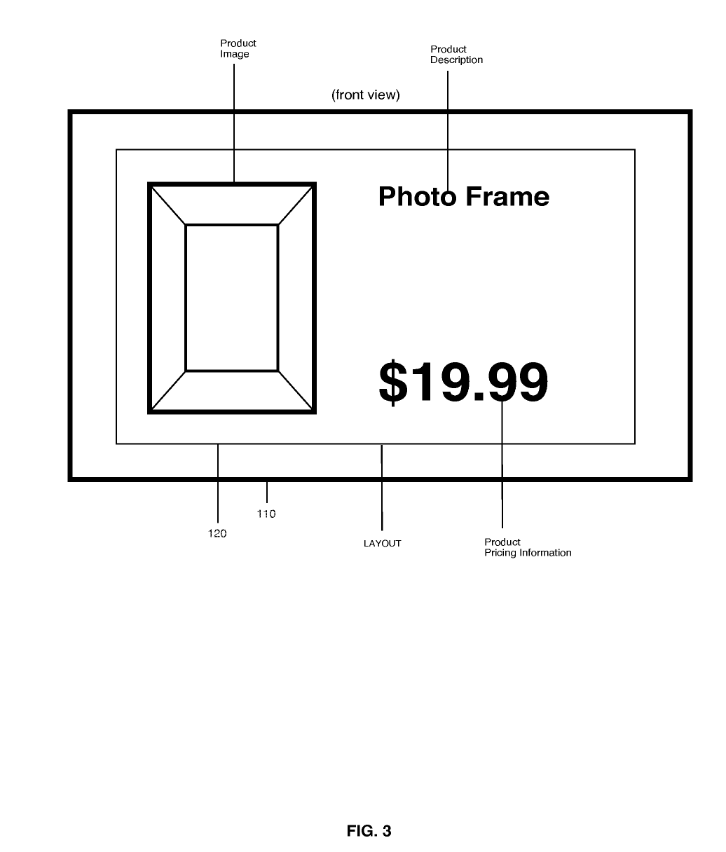

FIG. 4 shows a block diagram structure of a Multilanguage Self-Contained Unmanaged Database-Driven Real Time Digital Advertising Display System shown in FIG. 1 according to the present invention.

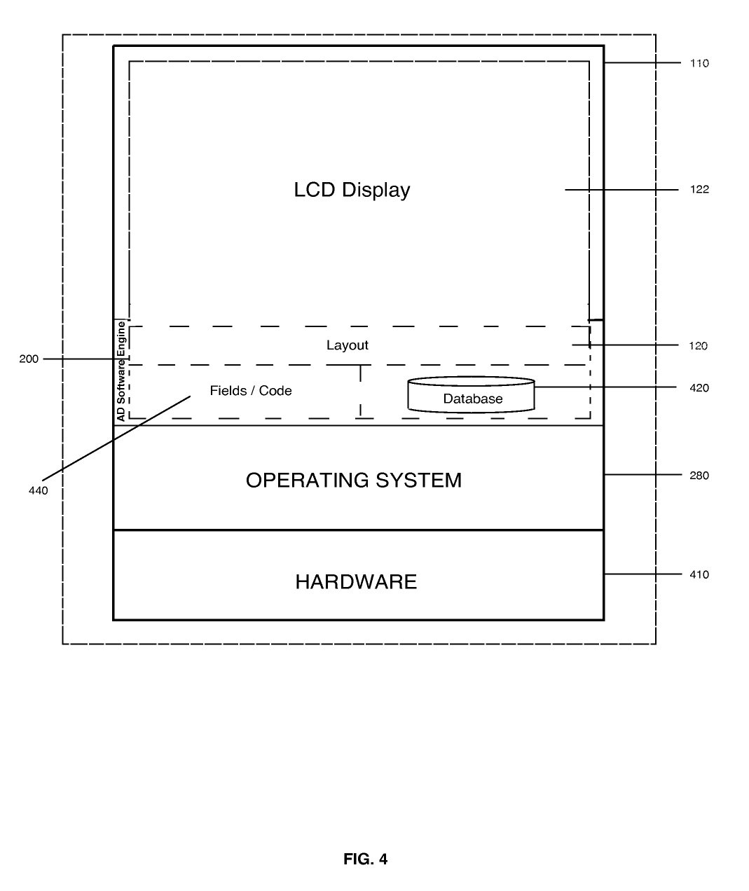

FIG. 5-5A (enlarge view of Corporate database server) illustrates a wireless broadband connection from central location to the group of mobile advertising systems that mounted on a roof and inside of the vehicles via mounting assembly according to the present invention.

FIG. 6 illustrates the mobile advertising system installed on the roof of the vehicle via mounting assembly according to embodiment of the present invention.

FIG. 7 illustrates the mobile advertising system mounted on the rear passenger door of a vehicle via mounting assembly according to the present invention.

FIGS. 8-8A an enlarged view flowchart diagram that illustrates electrical wiring connection to the battery for the mobile Multilanguage Self-Contained Unmanaged Database-Driven Real Time Digital Advertising Display System shown in FIG. 1 according to the present invention.

FIG. 9 illustrates the mobile advertising system installed inside the rear part of the vehicle and on a roof of the vehicle, side by side, via mounting assembly according to embodiment of the present invention.

FIG. 10 is a diagram that illustrates how the Multilanguage Self-Contained Unmanaged Database-Driven Real Time Digital Advertising Display System is connected inside the store to the internet through a Wireless Router and/or High Speed Internet Modem. A printer is connected to a display system to print promotional signs in a store, shown in FIG. 1 according to the present invention.

FIG. 11 illustrates the set up/mounting inside the store—front view; rear view; side view, shown in FIG. 1 according to the present invention.

FIG. 12 is a flowchart diagram that illustrates the operation of an AD Software Engine module shown in FIG. 1.

FIG. 13 is a flowchart diagram that illustrates detailed operations of the Multilanguage Self-Contained Unmanaged Database-Driven Real Time Digital Advertising Display System shown in FIG. 1 according to the present invention.

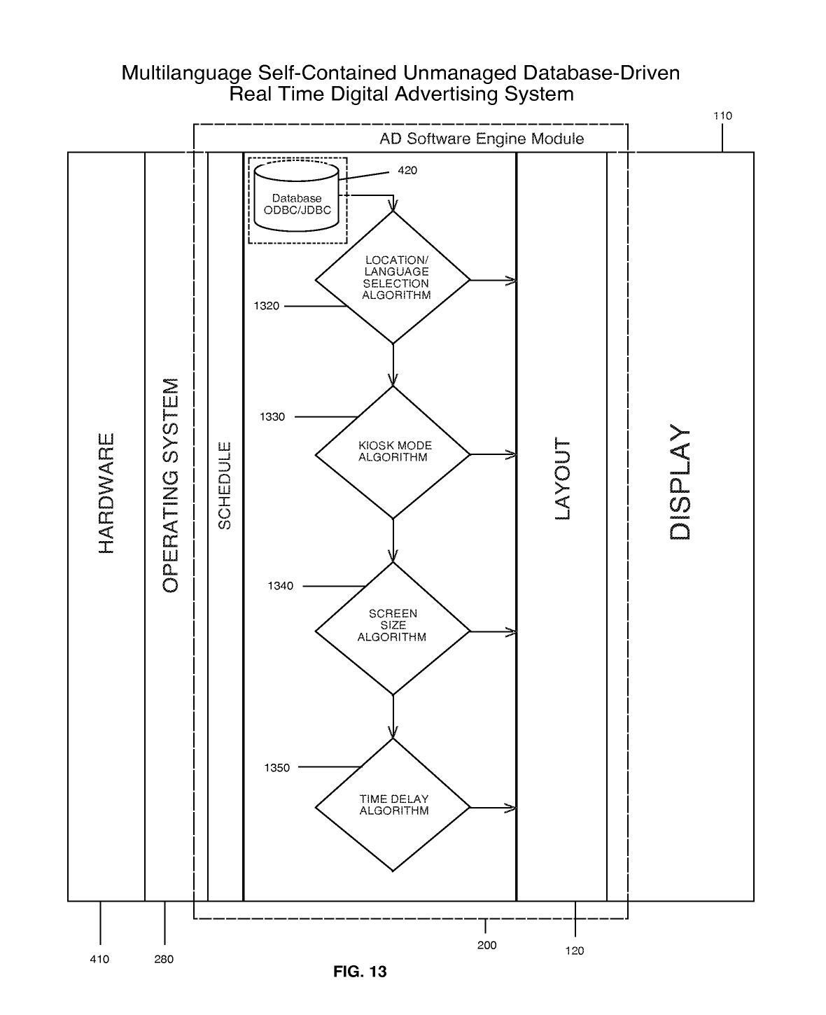

FIG. 14 shows a rear view of diagram connection a Multilanguage Self-Contained Unmanaged Database-Driven Real Time Digital Advertising Display System to a commercially available or custom made build-in smart phone.

FIG. 15 illustrates how the advertising device can be set up/mounted inside of the vehicle on a front dashboard.

### DETAILED DESCRIPTION

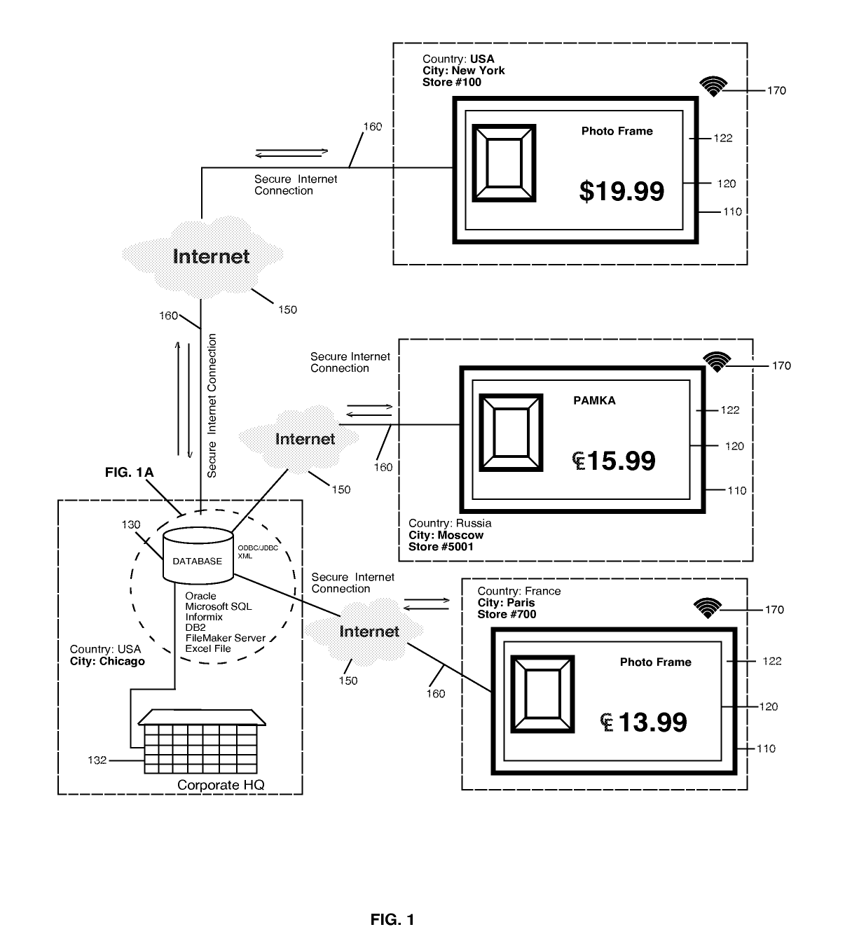

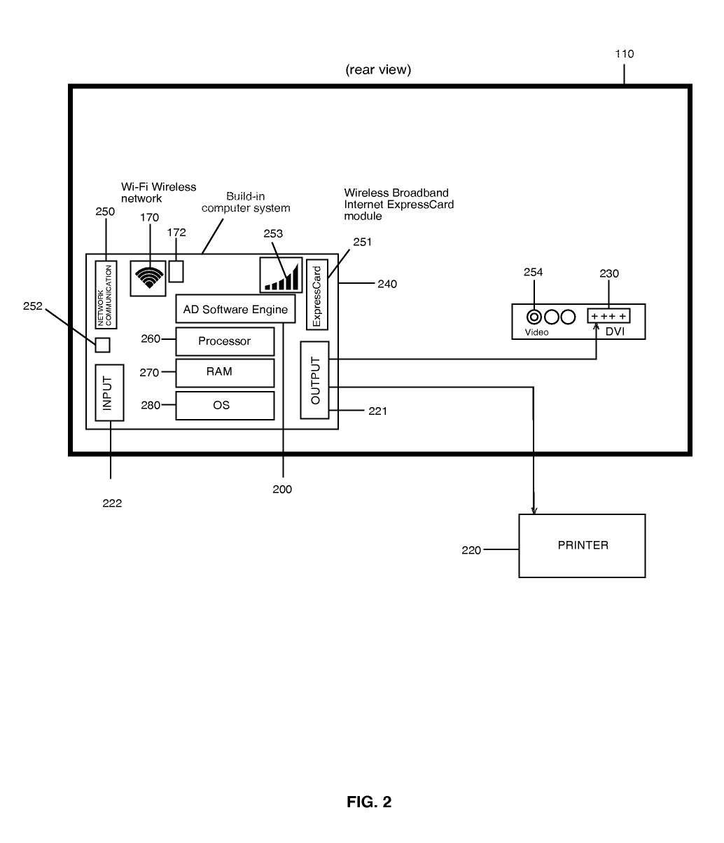

FIGS. 1 AND 2 illustrates an example system 110 for advertising. As indicated in these figures, the system 110 comprised of a commercially available or custom made build-in desktop/portable computer 240 and commercially available or custom made LCD display 122, network-enabled devices 250, modem 252, wireless network device 170 and ExpressCard 251

As further indicated in FIG. 1 the database server 130 and the network-enabled 110 advertising display device are connected to a network 160 through wireless devices 172. By way of example, these networks can include one or more local area networks (LANs), wireless and/or wide area networks (WANs) 170. Typically, however, the network 160 comprises a set of networks that forms part of the Internet. The system 110 further comprises of advertising displays device that, as indicated in FIG. 1, are wirelessly and securely connected to the database server 130 utilizing TCP/IP, ODBC, JDBC, XML technology.

The processing device 260 can include any custom made or commercially available processor, a central processing unit (CPU), or a microprocessor. The memory 270 can include any one of a combination of memory elements (e.g., random access memory (RAM, such as DRAM, SRAM, etc.).

The one or more device interface elements 250, which typically comprises of hardware, used to electrically connect the database server 130, so that the data can be sent and received between devices. Therefore, by way of example, the device interface elements 240 can comprise of one or more external buses and/or communication ports. By way of example, the network interface devices 250 includes components that communicates both through inputs and outputs, for instance, a modulator/demodulator (e.g., modem), a radio frequency (RF) or other transceiver, a telephonic interface, a bridge, a router, etc.

Memory 270 has various software programs which includes an operating system 280, a print service module 220. The operating system 280 controls the execution of other software, such as the AD Software Engine module 200, and provides scheduling, input-output control, file and data management, memory management, and communication control and related services. The advertising display device 110 preferably comprises AD Software Engine module 200 that display of advertising material to users. AD Software Engine module include option to print promotional signs in a store, it works with any printer drivers needed to communicate with the printer 220.

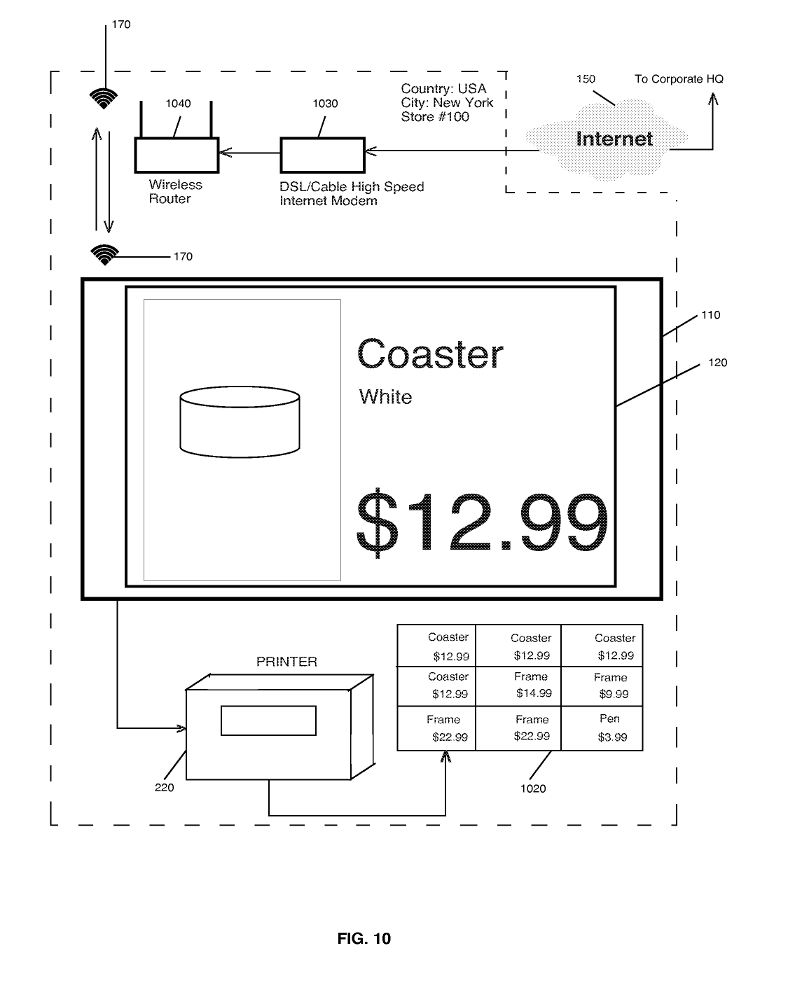

For example, as discussed in greater detail below with reference to FIG. 10, the advertising module 110 can be configured to facilitate the printing of advertised promotional signs (small, medium, large) on hardcopy prints (i.e., printer printouts) and later distributed to a store. The wireless router 1040, in conjunction with the network interface devices 170, facilitates network communications for the DSL/Cable high speed internet modem 1030. In addition to the AD Software Engine module comprises a database 420 that can be used to store advertising material and be distributed to the “user” in case of the internet connection problem from the central database server.

During the execution the unique identifier assigned to advertising system has to be identified in order to determine the location and language, example shown in FIG. 1 Country: USA will display appropriate layout with correct language, country: Russia will display correct layout and language.

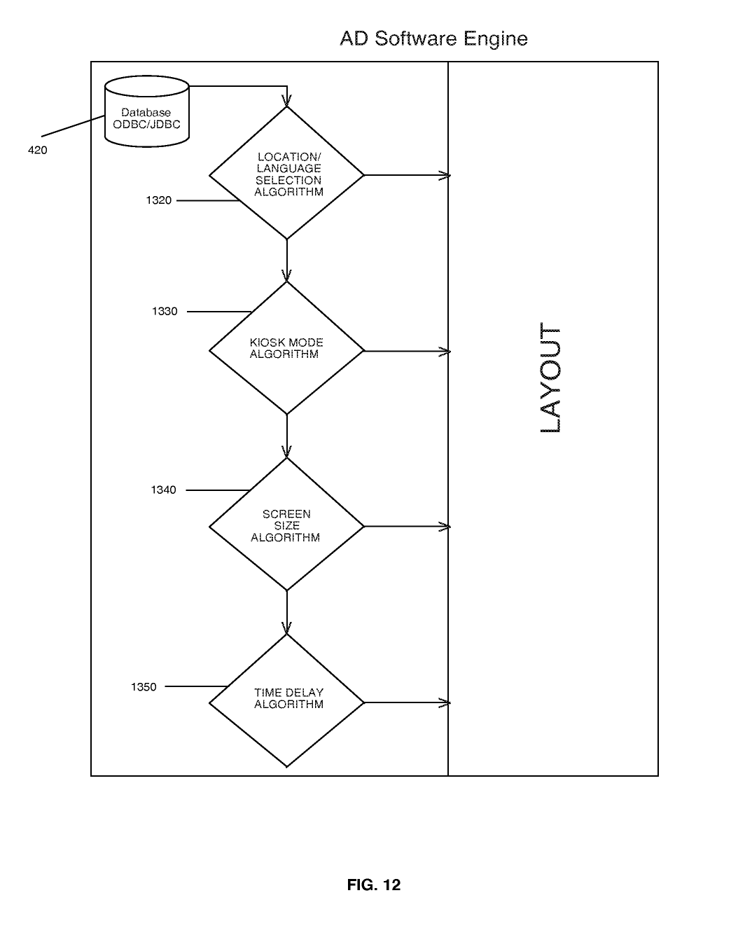

The memory 270 includes various software and/or firmware programs including an operating system 280. The operating system 280 contains the various commands used to control the general operation of the network-enabled device 110. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a random access memory (RAM), a read-only memory (ROM). As indicated in FIG. 12, the AD Software Engine module Location/Language Selection Algorithm 1320 is first initiated, its then, triggers the Screen Size Algorithm 1340 which adjusts advertising layout to a correct size of the screen. Time Delay Algorithm 1350 will control the intervals of displaying items. By way of example, advertising information will be displayed directly from a remote database server or can be displayed from a locally stored AD Software Engine module database.

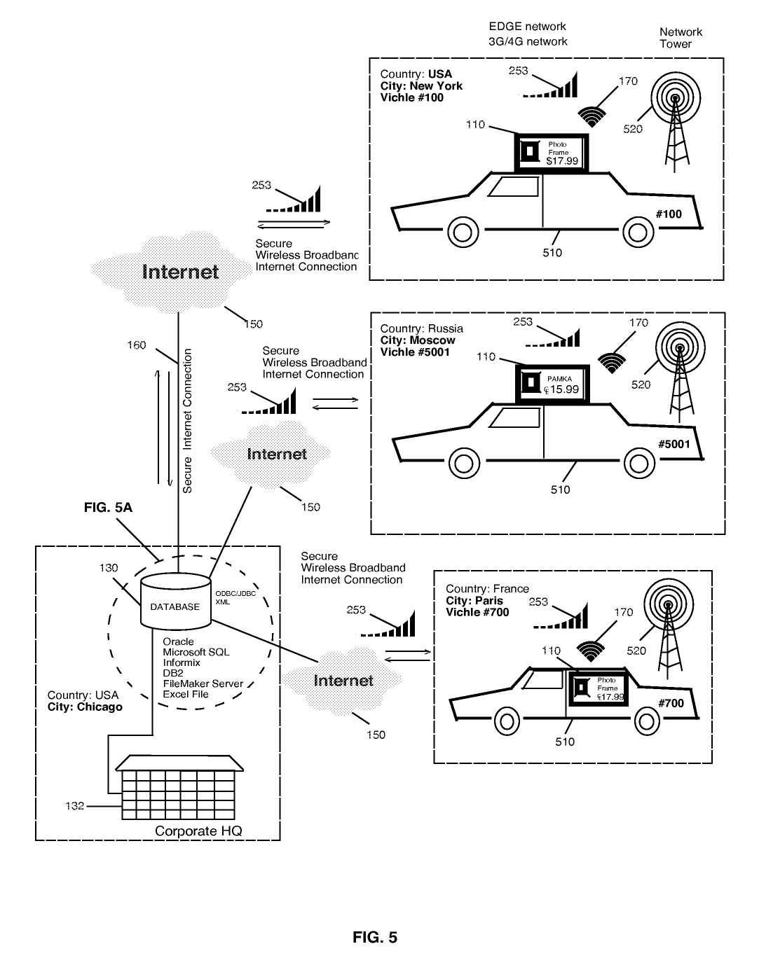

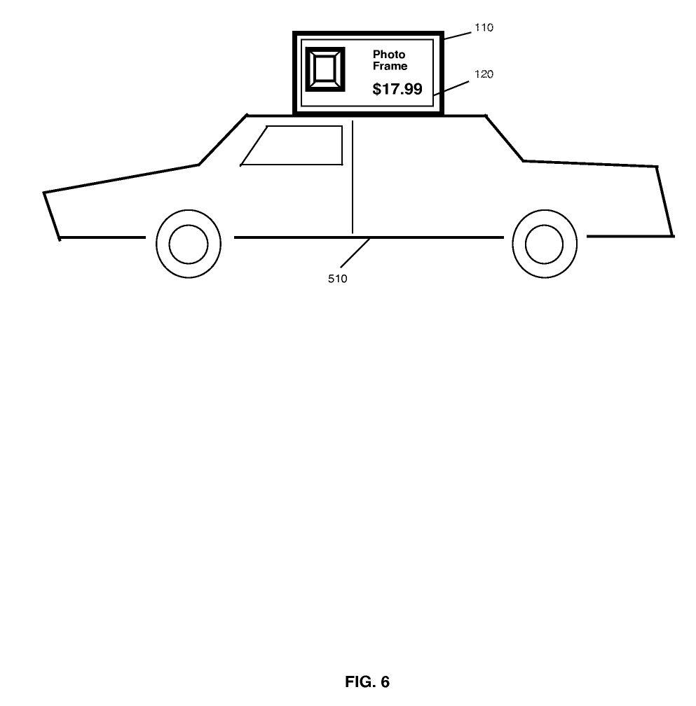

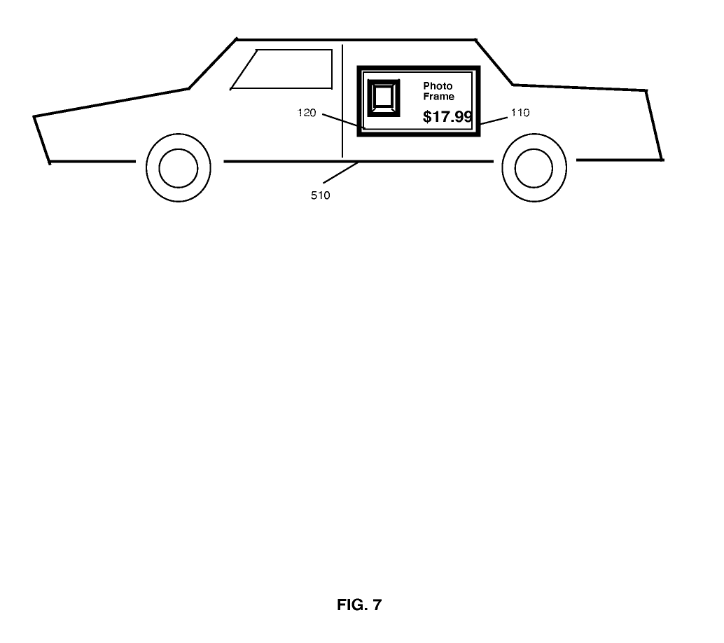

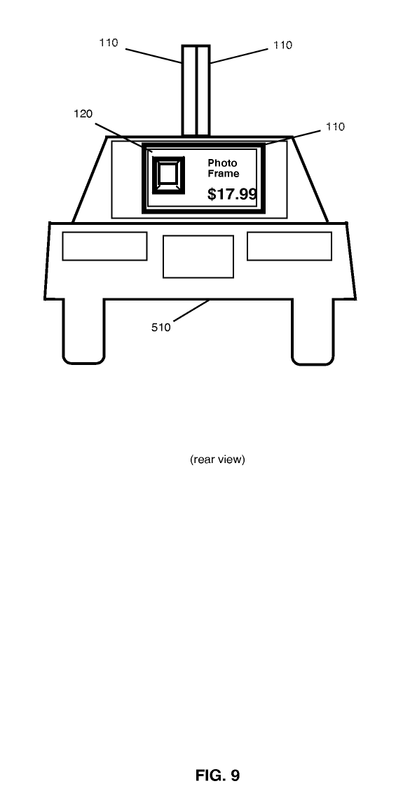

FIGS. 5-6-7-8-9 illustrates the group of mobile advertising display devices that have wireless broadband enabled network that allow communicating with central location database server. In places with weak network reception, the mobile advertising display device will get a new updates at a store location synchronizing AD Software Engine module database 420.

By way of example, every mobile advertising system has a unique identifier and GPS system, which will allow the Corporate HQ easily trace current location of advertising vehicle according to embodiment of the present invention.

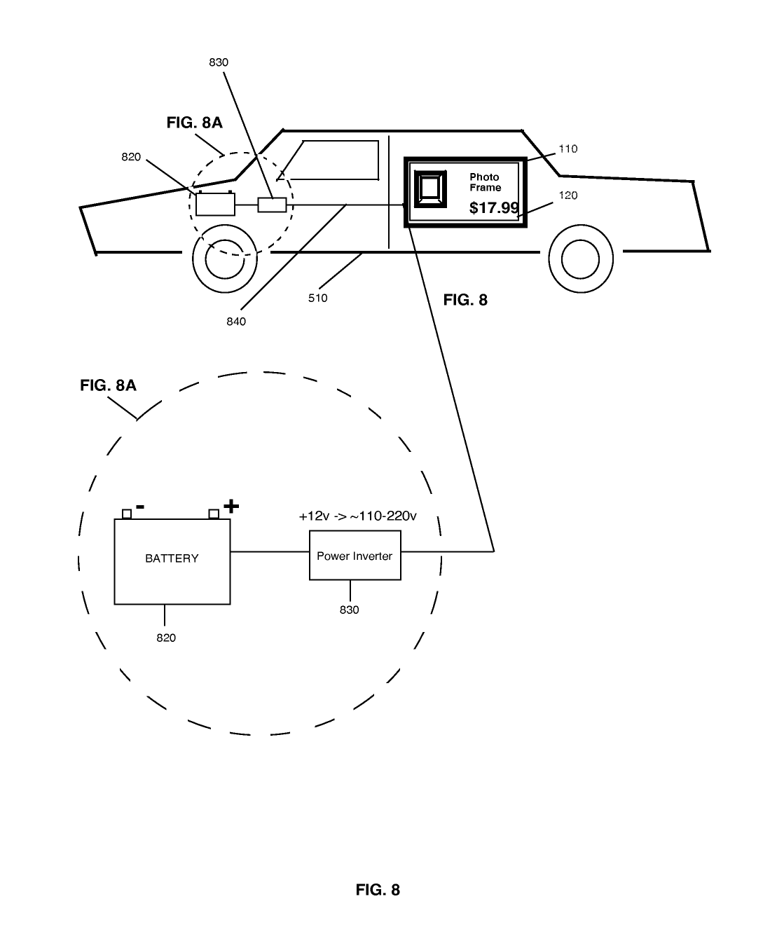

FIGS. 8-8A (enlarge view) are illustrating wiring connection schematic for a Multilanguage Self-Contained Unmanaged Database-Driven Real Time Digital Advertising Display System shown in FIG. 1 according to the present invention.

Commercially available or custom made power inverter is used to convert +12V direct current to 120-220V alternating current that will allow to power up advertising display device on vehicle. The additional backup battery can be installed in trunk of the vehicle.

FIG. 10 illustrates how advertising display device communicates via wireless network card 170. Wireless connection established with wireless router 1040, DSL/Cable High Speed/Fiber optics 1030 to Internet 150.

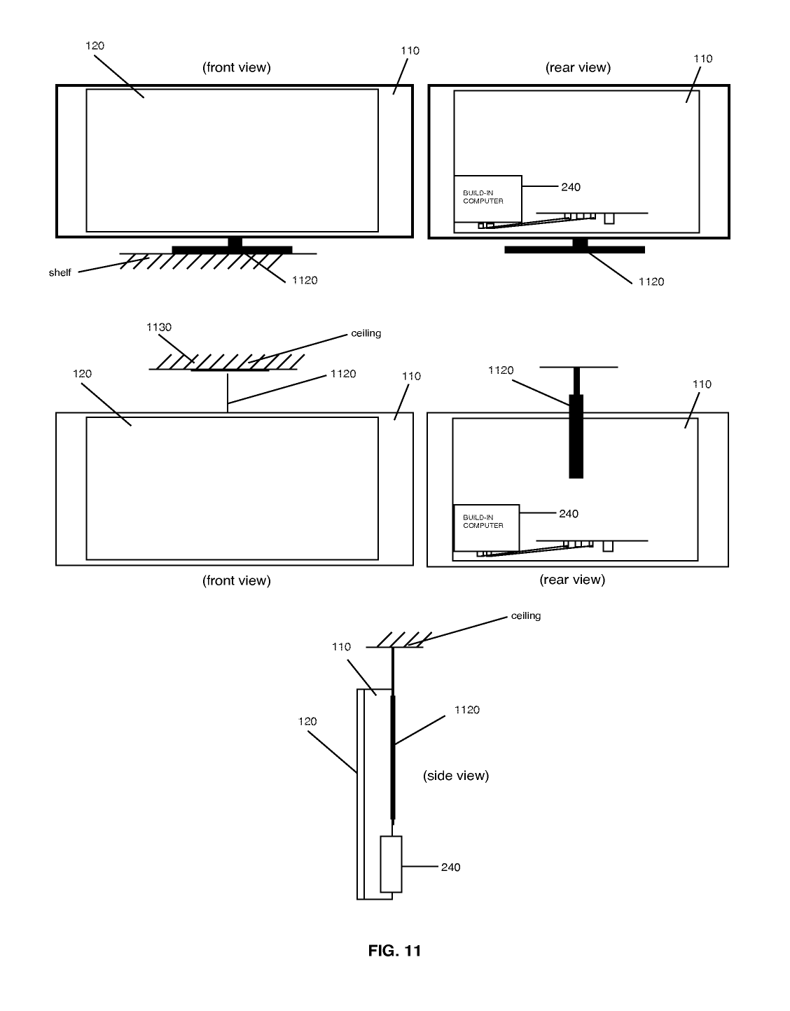

FIG. 11 is a flow diagram that illustrates how in store advertising device can be set up shown in FIG. 1 according to the present invention. Advertising device will be installed on the shelf or mounted under the ceiling via mounting assembly according to embodiment of the present invention.

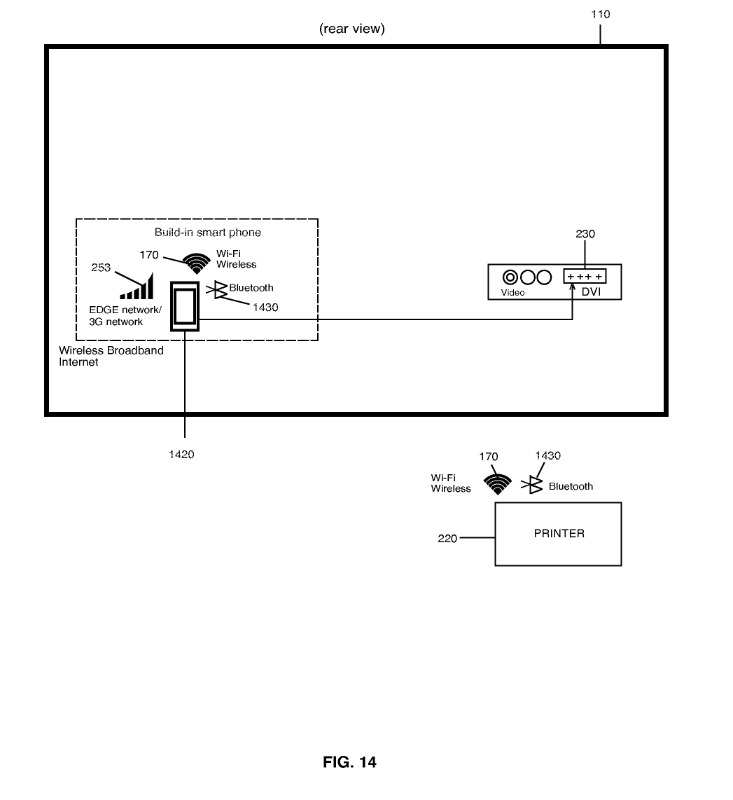

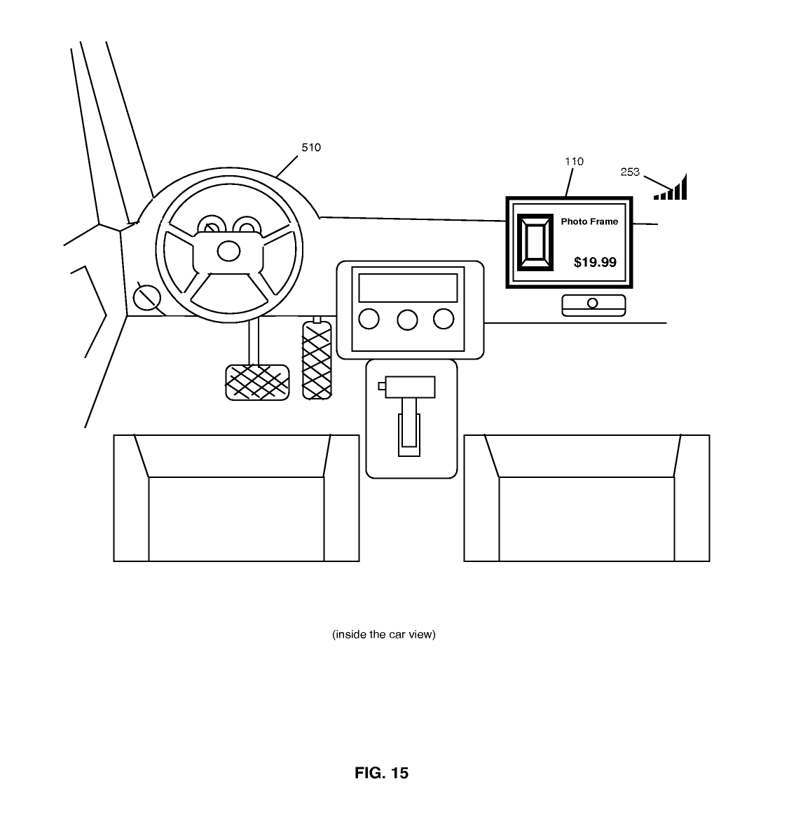

FIGS. 14-15 are a flow diagram that illustrates operation of an AD Software Engine module shown in FIG. 1 according to the present invention. Information from remote database server accessed by AD Software Engine module though TCP/IP, ODBC or JDBC drivers. Updated schedule will be run during the night hours on advertise display device. As new information comes into a remote database server, the AD Software Engine module will update its internal database automatically to reflect any last minute changes, additions or modifications.

### Drawing Reference Numerals Worksheet

### Item Name:

110—Multilanguage Self-Contain Unmanaged Database-Driven Real Time Digital Advertising Display System (system for advertising, advertising display device)
120—Layout of AD Software Engine module
122—LCD Display
130—Corporate database (Oracle, Microsoft SQL, MySQL)
132—Corporate HQ
150—Internet
160—Secure Internet Connection
170—Wireless Network
172—Wireless Network card
200—AD Software Engine module
220—Printer
221—Output
222—Input
230—DVI video Input
240—Build-in computer system
250—Network Communication interface
251—Wireless Broadband Internet ExpressCard module
252—Modem
253—Wireless Broadband Internet
254—Video input
260—Processor
270—RAM
280—OS (operating system)
410—Hardware
420—Database
440—Fields, Code
510—Vehicle
520—Network Tower
820—Battery
830—Power Inverter
1020—Sign printouts
1030—DSL/Cable High Speed Internet Modem/Fiber optics
1040—Wireless Router
1120—Shelf
1130—Ceiling
1320—Location/Language Selection Algorithm
1330—Kiosk Algorithm
1340—Screen Algorithm
1350—Time Delay Algorithm
1420—Build-in Smart Phone
1430—Bluetooth

### DRAWINGS

The objects and features of the invention will become more readily understood from the following detailed description and appended claims when read in conjunction with the accompanying drawings.

FIG. 1 illustrates a system of the invention:

I claim:

1. Multilanguage Self-Contained Unmanaged Database-Driven Real Time Digital Advertising Display System is comprised of at least one build-in computer that has an electronic communication to a database server, and will display at least one advertisement on number of electronic displays.

2. According to claim 1, AD Software Engine is installed in the build-in computer system of the advertising display device that will convert database server industry standard database format file to customer friendly output to advertised products and services, and will allow stores employees to print promotional signs as necessary. The display system will also update or delete information as often as needed from any device that is being used.

3. Hardware: Commercially available or custom made build-in desktop or portable computer.

4. Network: Wireless Router, Wireless Card, Wireless Broadband Card, High Speed Internet DSL/Cable modem.

5. Multilanguage Self-Contained Unmanaged Database-Driven Real Time Digital Advertising Display System according to claim 1, wherein a predetermined subset of the plurality of advertisements are simultaneously displayed on the predetermined number of electronic displays.

6. Multilanguage Self-Contained Unmanaged Database-Driven Real Time Digital Advertising Display System will display data from corporate database server which will be securely available in real time at any store in a world via Internet with DSL, T1/T3 Line, High Speed Internet Cable Modem, Wireless Broadband Network, Dial-up connection utilizing VPN (Virtual Private Network), SSH, SSL2/3 secure technology at any location.

7. According to claim 1, no physical interactions, such as changing signs or billboards, are necessary due to the Multilanguage Self-Contained Unmanaged Database-Driven Real Time Digital Advertising Display System and AD Software Engine.

8. According to claim 1, all and any changes in the signage pricing information will be done via Multilanguage Self-Contained Unmanaged Database-Driven Real Time Digital Advertising Display System and AD Engine Software module.

9. Control, support and maintenance are done remotely at the central location (Corporate HQ).

10. According to claim 1, contents, data, text and image information will be changed dynamically, record by record displaying available advertised product or advertised services from the database.

11. The coding algorithm, executed on Multilanguage Self-Contained Unmanaged Database-Driven Real Time Digital Advertising Display System, will find correct location and set appropriate language.

12. The coding algorithm, executed on Multilanguage Self-Contained Unmanaged Database-Driven Real Time Digital Advertising Display System, will set the screen to kiosk mode.

13. The recognition algorithm will be adjusting the screen size during the execution to properly display advertised products.

14. Multilanguage Self-Contained Unmanaged Database-Driven Real Time Digital Advertising Display System will update new information via local network or Internet by utilizing a schedule application that will build upon an operating system of an advertising display device computer or executing remote schedule application from Corporate HQ.

15. During the internet connection problem, the data from central advertising location database server can be stored, in prior for execution, on internal AD Software Engine module database. In addition, the excel worksheet file, text, comma delimited files can be saved at Corporate HQ, copied to a CD, DVD, SmartDisk, Flash Memory Card along with images JPEG, GIF format and send by regular mail to any location where the files and images can be automatically loaded into AD Software Engine module and displayed on Multilanguage Self-Contained Unmanaged Database-Driven Real Time Digital Advertising Display System.

16. The electronic display is available in all sizes and could be mounted on any transportation—Bus, Car, Taxi, Trucks, etc., to advertise and promote products or services in any language. The electronic display is protected from inclement weather by a protective enclosure.

17. All advertised information will be displayed either on Wide Screen Computer Monitors, Wide Screen Plasma TV, LCD Monitor or CRT Television.
